(19) United States
(12) Patent Application Publication
(10) Pub. No.: US 2025/0321088 A1
(43) Pub. Date: Oct. 16, 2025

(54) DEVICE AND SYSTEM FOR MONITORING A DEFORMATION OF A SHELVING

(71) Applicant: Thenextpangea, S.L, Gozón - Asturias (ES)

(72) Inventors: Marcos PÉREZ RODRÍGUEZ, Gozón - Asturias (ES); Luis Miguel SANZ MORAL, Gozón - Asturias (ES); Guillermo REGO FERNÁNDEZ, Gozón - Asturias (ES); José RICO FERNÁNDEZ, Gozón - Asturias (ES); Virgilio GARCÍA ORGEIRA, Gozón - Asturias (ES); Pedro MONGELOS GARCÍA, Gozón - Asturias (ES); David NORIEGA PÉREZ, Gozón - Asturias (ES)

(21) Appl. No.: 18/870,038

(22) PCT Filed: Apr. 18, 2023
(86) PCT No.: PCT/ES2023/070239

§ 371 Date: Nov. 27, 2024

(30) Foreign Application Priority Data
May 27, 2022 (ES) P202230458

(51) Int. Cl. G01B 7/16; G01L 1/18; G01L 1/22; G01M 5/00

(52) U.S. Cl. CPC G01B 7/18; G01L 1/18; G01L 1/2206; G01L 1/2287; G01M 5/0083

(57) ABSTRACT

Device and system for monitoring a deformation of a shelving. The device includes a substrate, a protective layer, a piezoresistive layer with a matrix layer of electrical insulating material and with conductive particles of graphene or graphene oxide dispersed within the layer of insulating material, with the conductive particles forming a conductive porous network. It also includes a communications unit and a processing unit and anchoring element to be attached to a structural element of the shelving. The system includes one or more devices, an external communications unit and a graphical interface.

### FIELD OF THE INVENTION

The invention belongs to the field of maintenance and/or prevention in industrial installations, more specifically it is related to monitoring systems for the deformation of structures.

### BACKGROUND OF THE INVENTION

Currently, the most widespread method for monitoring the status of an industrial shelving is visual inspection by maintenance operators. This method may be suitable for small industrial installations. In installations with a larger area or with the need for continuous monitoring, visual inspection has significant disadvantages.

Logistics centers typically have a large number of shelving. Each shelving is structurally composed of struts, diagonals and crossbars. Additionally, there are usually mechanisms to join some shelving to others, and these to the floor. A shelving is anchored to the floor by means of screws.

The strut is one of the structural elements of the shelving that is most susceptible to suffering damage of different kinds. It is common for there to be a large number of struts in a logistics center, even in the order of tens of thousands. Visual inspection becomes impractical in such environments, it may require several operators periodically evaluating the state of the struts, which can take several days and even a week. Not only is it a laborious task, it is also imprecise. There is damage that is difficult to see with the naked eye. Either because they are small deformations, or because the objects stored on the shelving prevent identification. Human errors are common in these types of circumstances. In addition, this visual inspection can lead to safety risks for inspectors, who must be at the plant while the forklifts continue to operate, or in production losses by having to stop them for the duration of the inspection.

A frequent source of damage to shelving is due to collisions caused by forklifts loading and unloading pallets, which often go unnoticed even by the forklift operators themselves. Thus, from the time damage occurs until it is identified, several days may pass. This poses a risk to the integrity of the shelving and warehouse operations.

Along with the struts, other structural elements of a shelving can be damaged by excess load, falling merchandise, etc. This complicates monitoring and maintenance. In general, the proposals capable of warning that an impact has occurred do not quantify the deformation derived from it and, if they do, such as strain gauges, provide very localized information, which is not practical due to the amount of wiring that would be involved in monitoring the critical zone of a strut.

In the state of the art there are also developments based on other technologies. It is worth noting certain proposals that use images captured by cameras, some that use accelerometers or others that are based on fiber optics. They all share being faster than visual inspection, but suffer from other problems. To name a few, the cameras would not be able to quantify the magnitude of the impact. As for the accelerometers, although they are capable of registering the intensity of the shock caused to the strut, they do not provide direct information on the deformation that it has suffered as a result of the shock. On the other hand, the integration of optical fiber in a warehouse presents problems in terms of robustness against damage during operation (for example, if the fiber is torn). A more robust integration, with segmentation of the fiber in different sections, would require very expensive interpretation electronics.

It would be desirable a solution that remedies existing drawbacks, that facilitates monitoring in an effective, quantified, efficient and real-time manner, especially in industrial environments, where preventive action saves significant material costs, working hours, productivity improvements and dealing with the client.

### DESCRIPTION OF THE INVENTION

It is the object of the invention a device to monitor a deformation of a shelving according to the independent claim which is conceived in view of the problems identified. Particular embodiments of the invention are defined in the dependent claims.

According to various embodiments of the present invention, a more economical solution is exposed than other existing ones mentioned, which allows to instantly know the state of deformation of elements of a shelving, such as the struts, and which determines the degree of affectation to quantify levels of deformation of the structure and, therefore, the state of the struts. The properties of a piezoresistive ink, for example, one based on graphene or reduced graphene oxide, are used to design a device capable of continuously or at a predetermined frequency monitoring the status of a shelving and instantly responding to a deformation. This type of monitoring is distributed over multiple locations of interest that can be properly monitored.

In the present invention, the terms are used with their conventional meaning. However, for greater clarity and ease of understanding, the following definitions are provided.

By “graphene” is meant a family of materials with the characteristics of being composed of one or up to 10 layers of carbon atoms bonded by sp²-type covalent bonds forming a honeycomb structure in the basal plane.

By “reduced graphene oxide” is meant graphene with an oxygen percentage of less than 20% and greater than 1% that has been produced following the oxidation-reduction route of graphite.

### BRIEF DESCRIPTION OF THE FIGURES

Embodiments of the present invention are described, by way of example only, in the accompanying drawings in which similar elements are numbered the same in the various Figures:

FIGS. 1A-1D It is a schematic representation (not to scale) according to a structural diagram with some important parts of the device. FIG. 1A without deformation. FIG. 1B with deformation. FIG. 1C cross-sectional view with conductive track without deformation. FIG. 1D longitudinal view with conductive track without deformation.

FIG. 2 is a schematic representation of a shelving with the device installed.

FIG. 3 It is a real image of a sticker with the piezoresistive layer seen from the front.

FIG. 4A is a schematic representation of the installation and operation process.

FIG. 4B It is a detail of the electronic part of the device.

### GLOSSARY OF REFERENCE NUMBERS

1 Shelving.
2 Diagonal.
3 Horizontal.
4 Strut.
5 Shelf.
6 Anchor.
10 Device for monitoring deformation.
11 Piezoresistive layer.
12 Substrate.
13 Insulating matrix layer.
14 Protective layer.
15 Conductive lattice structure.
16 Conductive track.
17 Communications unit.
18 Resistivity measurement unit.
19 ADC converter.
20 External communications unit.
21 Graphic interface.
22 Processing unit.
23 Amplifier.

### DESCRIPTION OF EMBODIMENTS

With reference to the previous figures, without limitation, various embodiments of the invention are presented for a better understanding.

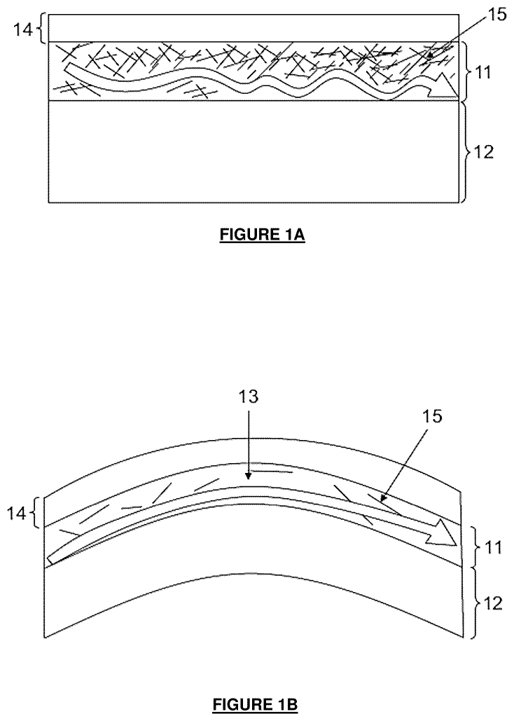

FIGS. 1A-1B show the internal structure of a part of the device 10 without and with deformation according to one embodiment (without conductive tracks). The device 10 is installed on a surface to monitor if it deforms. For example, it is installed using anchoring means (adhesive, mechanical fastening with screws, fittings, etc.) so that the deformation experienced by the part or structure is transferred to the device 10.

The device 10 includes a piezoresistive layer 11 generated from a matrix layer 13, of electrically insulating material (for example, non-conductive resin) in which conductive particles 15 are dispersed (for example, based on graphene) generating a porous network with also conductive properties. This gives rise to conductive paths that change with deformation, this being the operating principle of the present device 10. The piezoresistive layer 11 rests on a substrate 12 and is connected to the electronics in charge of interpreting the signal that the piezoresistive layer 11 generates, and transmitting it to an external communications unit 20.

In one embodiment, the piezoresistive layer 11, can be created by mixing conductive particles (for example, graphene or graphene oxide), by means of a high-revolutions shearing process on a first component A of the resin composing the matrix layer 13. A second component B is then mixed such that the viscosity of the piezoresistive layer 11 is less than 1000 Pa·s and resistivities less than 3.6 MΩ/□ are obtained for thicknesses of 100 mm, measured with Vermason® with the 4-point method and having applied a paint with graphene or graphene oxide on the substrate 12 by screen printing technique, inkjet, spray or similar techniques that allow controlling the amount of material deposited and the geometry of the piezoresistive layer.

Thus, a porous network of conductive particles 15 (graphene) is obtained in the piezoresistive layer 11. It is porous since internally, in the piezoresistive layer 11 there are gaps between the different conductive particles that are amplified or reduced depending on the deformation suffered by the assembly. This results in a change in the electrical resistance of the piezoresistive layer 11, from which the deformation that it has suffered can be derived. With electronic means, information can be measured and sent in this regard. These aspects will be discussed later.

The piezoresistive layer 11 can be designed according to different dimensions. Generally, it is characterized by a thickness of 20 to 500 microns, preferably between 60 and 200 microns, depending on the desired conductivity in the application and a length of between 2000 mm and 50 mm, preferably between 1500 mm and 200 mm and a width between 1 mm to 100 mm, preferably between 15 mm and 50 mm. The length and width can be modified according to the geometry of the structure to be analyzed. Matrix layer 13 behaves as an electrical insulator, with resistivities above thousands of MW·m.

Substrate 12 can be created with a flexible plastic polymer with an adhesive outer face to be attached, like a sticker, to the structure whose deformation is to be monitored. They are suitable materials for substrate 12: acetate, polyvinyl, polyethylene, polyethylene terephthalate, polyimide, polyester, for example. Substrate 12 can also be generated by deposition of a previous layer of an insulating material, whose application is prior to the application of the formulation for the piezoresistive layer 11.

FIGS. 1C-1D show two views of the internal structure of a part of the device without deformation according to an embodiment of the device 10 including some conductive tracks 16 of higher conductivity than the piezoresistive layer 11 (e.g., silver, copper) allowing conductivity measurement of the piezoresistive layer 11. The conductivity of the conductive track is less than 30 mΩ/□ for a layer of 25 mm measured according to the 4-point method. In FIGS. 1C-1D a connection diagram between piezoresistive layer and conductive layer is included.

In the absence of deformation, the device 10 provides a resistivity reading based on percolation of conductive particles 15 dispersed in the matrix layer 13 of insulating material that forms the piezoresistive layer 11. For this, the device 10 has electronics of measurement and interpretation.

When the surface to be analyzed is subjected to a deformation, the piezoresistive layer 11 is equally deformed and said deformation is translated into a change in the contact of the conductive particles 15 that form a porous network inside the matrix layer 13 of insulating material, increasing or decreasing the resistivity according to the type of deformation.

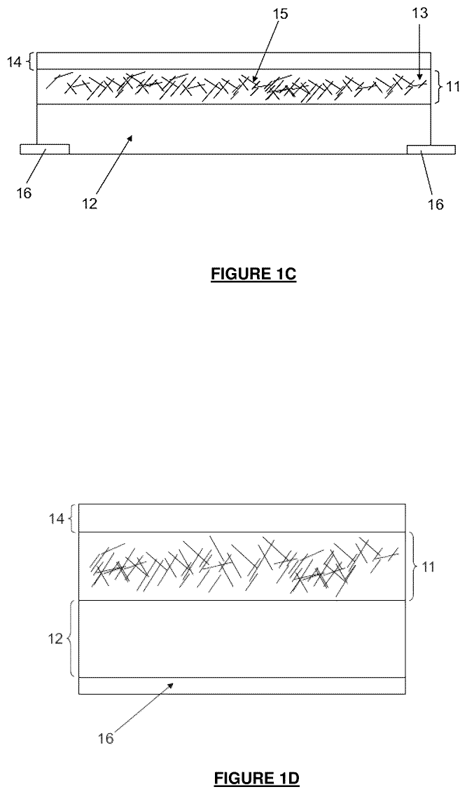

FIG. 2 schematically represents the typical structure of a shelving 1 in an industrial environment where the device 10 has been installed in two of its struts 4. The shelving 1 has reinforcing elements such as horizontals 3 and the diagonals 2. The shelving 1 is attached to the floor via a base plate 6 with screws. The device 10 can be installed in the horizontals 3 and the diagonals 2 if desired. Also, under the shelf 5.

Thus, a monitoring system with multiple devices 10 can be deployed, an external communications unit 20 and a graphical interface 21 to monitor the deformation of different shelving 1 and/or several parts of the same shelving 1. If deformation is detected in an area of the shelving 1 monitored by a specific device 10, said device 10 generates a message that is sent, preferably wirelessly, to the external communications unit 20, and that can be displayed in the graphical interface 21 checked by an operator.

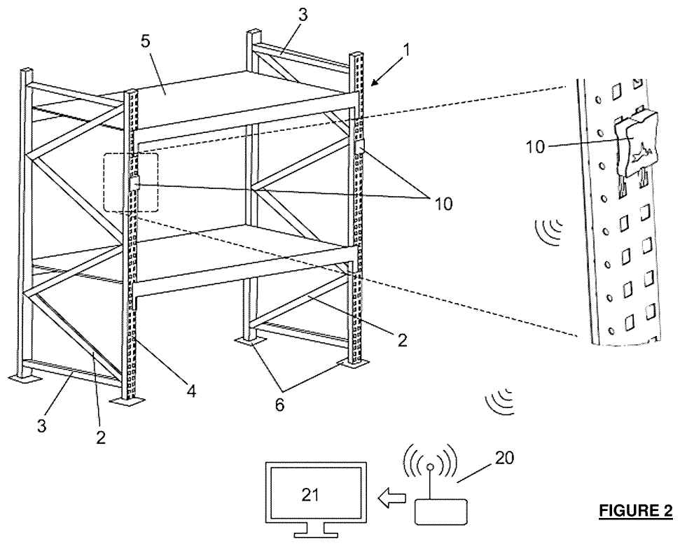

FIG. 3 shows a frontal image of a piezoresistive layer 11 where a structure of conductive tracks 16 can also be seen. The conductive tracks 16, for example, can be made with silver ink. It can also be seen how the piezoresistive layer 11 would be placed longitudinally, for example, on a shelving strut, by means of an adhesive. In this figure, the protective layer is not visible in the front view, as it is translucent.

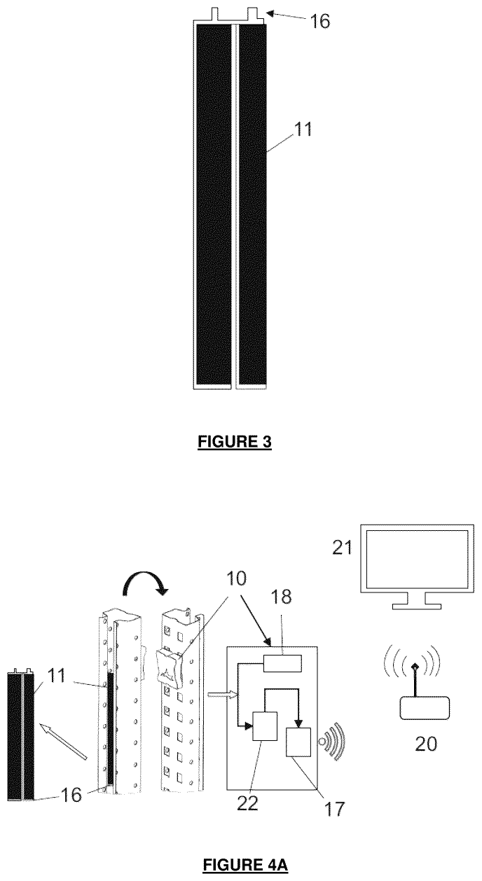

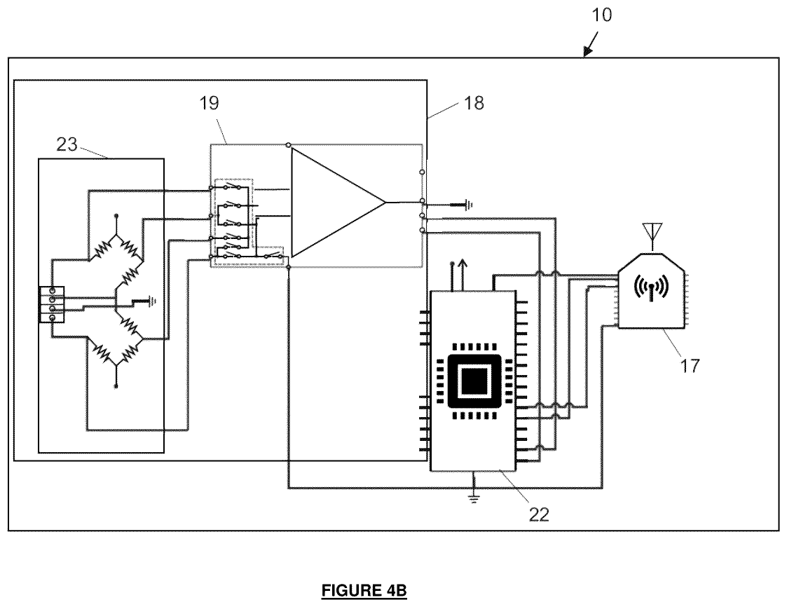

FIG. 4A schematically shows the process of installation and operation of the device 10. When a deformation occurs in the strut 4, the device 10 detects, through a measurement unit 18, a change in resistivity (or conductivity) in the piezoresistive layer 11 (replicates the deformation of the strut) and produces a message with a processing unit 22 that communicates through a communications unit 17 to an external communication unit 20, for example, a router, gateway, server, or the like, at a remote location.

A graphical interface 21, for example, a computer, a mobile terminal or the like, shows information on the status of the shelving for the maintenance operator. The communication between elements is preferably wireless (e.g., based on Zigbee), and can also be wired. In the case of the wireless solution, the data is collected by a central gateway that is responsible for sending it with a determined protocol (e.g., MQTT protocol), to a time series database for further processing and visualization.

The measurement unit 18 consists of an amplifier, which amplifies the analog signal of electrical resistance of the piezoresistive layer and an analog-to-digital converter, which converts the analog signal of electrical resistance of the piezoresistive layer 11 in a digital signal. Said digital signal is collected by the processing unit 22, which reads and transmits it to the communications unit 17.

When the piezoresistive layer 11 have surface resistance values less than 700 kW/□, it would be necessary to include an electromagnetic shielding of the measurement unit 18 to avoid unwanted interference and noise affecting the signal to be measured.

Together with the resistivity change detected, information relating to the identification of the shelving and even the specific element where it is installed is also included in the message, useful in the case of several devices per shelving. Several levels of affectation can be defined. Generally, with three levels, incidents and maintenance required in most situations can be adequately managed. For example, a slight level if the deformation is less than 5 mm; a medium level if the deformation is between 5 mm and 10 mm; a serious level if the deformation is greater than 10 mm. Naturally, both the number of levels and the intervals can be configured to suit different environments.

The device 10 is placed on the surface to be analyzed by means of an anchor, for example an adhesive layer on one side of the substrate 12. Also, as an option, the set of layers can be encapsulated with a protective layer 14 that seals and provides electrical insulation and/or hydrophobic character to the device 10 (or part of it), and protection against moisture and external agents. It should also be noted that, as a result of the application of the protective layer, the sensor is protected against vibrations produced by impacts, making the device 10 more robust. With the protective coating 14 it is protected from impact and the deformation is transmitted, without losing measurement sensitivity.

In FIG. 4B an example of implementation with commercial circuits of the measurement unit 18 is illustrated, responsible for measuring variations in the resistivity of the piezoresistive layer whose structure is shown in previous figures.

An amplifier 23 is appreciated (for example, Wheatstone bridge) that amplifies the analog signal of electrical resistance of the piezoresistive layer, an analog-to-digital converter 19 (for example, ADS1115) that converts the analog signal of electrical resistance of the piezoresistive layer into a digital signal so that a processing unit 22, (for example, an Arduino microcontroller) processes the digital signals and produces a message with data about the level associated with the measured resistance variation, the shelving identifier, etc. This data can be transmitted wirelessly by a communications unit 17 (for example, an XBee card).

The present invention is not to be construed as being limited to the particular embodiments described herein, but rather is determined by the scope of the appended claims.

1.-15. (canceled)

16. A device for monitoring a deformation of a shelving, comprising:
a substrate with a first exterior face and a second interior face, wherein the substrate is electrically insulating;
a protective layer with an outer face and an inner face, wherein the protective layer is electrical insulator;
a piezoresistive layer with a first face in contact with the interior face of the substrate and with a second face in contact with the interior face of the protective layer, wherein the piezoresistive layer comprises a matrix layer and a plurality of conductive particles dispersed within the matrix layer forming a porous network, wherein the matrix layer is electrical insulator;
anchoring means to fasten the piezoresistive layer to the shelving;
a measurement unit coupled to the piezoresistive layer, wherein the measurement unit is configured to measure a variation in the resistivity of said piezoresistive layer;
a processing unit for producing a message with information about the variation in resistivity;
a communications unit coupled to the measurement circuit and the processing unit, wherein the communications unit is configured to communicate the message with information about the variation in resistivity;
wherein the conductive particles of the piezoresistive layer comprise graphene or graphene oxide, wherein the piezoresistive layer is configured to be longitudinally placed on a structural element of a shelving and wherein the piezoresistive layer has a length between 2000 mm and 50 mm and a thickness between 60 and 200 microns.

17. The device for monitoring a deformation of a shelving according to claim 16, wherein the anchoring means comprises an adhesive on the exterior face of the substrate.

18. The device for monitoring a deformation of a shelving according to claim 16, wherein the substrate comprises one of the following materials: acetate, polyvinyl, polyethylene, polyethylene terephthalate, polyimide and/or polyester.

19. The device for monitoring a deformation of a shelving according to claim 16, wherein the protective layer is hydrophobic and encapsulates, at least partially, the device.

20. The device for monitoring a deformation of a shelving according to claim 16, wherein the piezoresistive layer has a thickness between 20 and 500 microns.

21. The device for monitoring a deformation of a shelving according to claim 16, wherein the piezoresistive layer has a length between 1500 mm and 200 mm.

22. The device for monitoring a deformation of a shelving according to claim 16, wherein the piezoresistive layer has a width between 1 mm and 100 mm.

23. The device for monitoring a deformation of a shelving according to claim 22, wherein the piezoresistive layer has a width between 15 mm and 50 mm.

24. The device (10) for monitoring a deformation of a shelving according to claim 16, wherein the processing unit is configured to include shelving identification data in the message.

25. The device for monitoring a deformation of a shelving according to claim 24, wherein the communications unit is wireless.

26. The device for monitoring a deformation of a shelving according to claim 24, wherein the communications unit is wired.

27. A piezoresistive ink based on graphene or reduced graphene oxide for use to design a device for monitoring a deformation of a shelving according to claim 16.

28. A system for monitoring a deformation of a shelving comprising one or more devices for monitoring a deformation of a shelving according to claim 16, an external communications unit configured to receive the message with information on the variation in resistivity of one or more devices, a graphic interface, associated with the external communications unit and configured to assign and display a plurality of levels at different values of variation in the received resistivity.
